(19) United States
(12) Patent Application Publication
(10) Pub. No.: US 2011/0130130 A1
(43) Pub. Date: Jun. 2, 2011

(54) METHOD FOR CONTROLLING A PORTABLE APPARATUS USED IN A TELECOMMUNICATION NETWORK, AND ASSOCIATED PORTABLE APPARATUS

(76) Inventor: Ya-jun Du, Hefei (CN)

(21) Appl. No.: 12/690,114

(22) Filed: Jan. 20, 2010

(30) Foreign Application Priority Data
Nov. 30, 2009 (CN) 200910225549.X

(51) Int. Cl. H04M 3/42

(52) U.S. Cl. 455/415

(57) ABSTRACT

A method for controlling a portable apparatus used in a telecommunication network includes: receiving a phone call from the telecommunication network; parsing a phone number from received information of the phone call; and displaying reference information including a calling history corresponding to the phone number during the phone call. An associated portable apparatus for being used in a telecommunication network includes a wireless communication module, a control circuit, and a user interface module. The wireless communication module is arranged to perform wireless communication. In addition, the control circuit is arranged to receive a phone call from the telecommunication network by utilizing the wireless communication module, wherein the control circuit parses a phone number from received information of the phone call. Additionally, the user interface module is arranged to display reference information including a calling history corresponding to the phone number during the phone call.

### BACKGROUND

The present invention relates to information management regarding a phone call, and more particularly, to a method for controlling a portable apparatus used in a telecommunication network, and to an associated portable apparatus.

As wireless communication technologies progress, and as mobile phones become smaller and more fashionable than those of years ago, many people have their own mobile phones handy for daily use. Typically, when receiving a phone call using a mobile phone implemented according to the related art, a user can see a contact number or a name displayed on a display module of his/her mobile phone. In a situation where communicating with a lot of persons using the mobile phone is required (e.g. the user is a very busy businessman or businesswoman), the user tends to feel confused since the only displayed information that the user may consider valuable regarding the phone call is the contact number or the name of the caller.

More specifically, in the situation mentioned above, it is sometimes difficult for the user to figure out the purpose of the phone call in advance or think of the commitment that the user already made to the caller in a previous conversion since there are many persons that the user should communicate with. Thus, a novel method is required in order to help such a user who tends to feel confused when receiving a phone call.

### SUMMARY

It is therefore an objective of the claimed invention to provide a method for controlling a portable apparatus used in a telecommunication network, and to provide an associated portable apparatus, in order to solve the above-mentioned problem.

An exemplary embodiment of a method for controlling a portable apparatus used in a telecommunication network comprises: receiving a phone call from the telecommunication network; parsing a phone number from received information of the phone call; and displaying reference information comprising a calling history corresponding to the phone number during the phone call.

An exemplary embodiment of an associated portable apparatus for being used in a telecommunication network comprises a wireless communication module, a control circuit, and a user interface module. The wireless communication module is arranged to perform wireless communication. In addition, the control circuit is arranged to receive a phone call from the telecommunication network by utilizing the wireless communication module, wherein the control circuit parses a phone number from received information of the phone call. Additionally, the user interface module is arranged to display reference information comprising a calling history corresponding to the phone number during the phone call.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a portable apparatus for being used in a telecommunication network according to a first embodiment of the present invention.

FIG. 2 is a flowchart of a method for controlling a portable apparatus used in a telecommunication network according to one embodiment of the present invention.

FIGS. 3-7 illustrate some implementation details of the method shown in FIG. 2 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

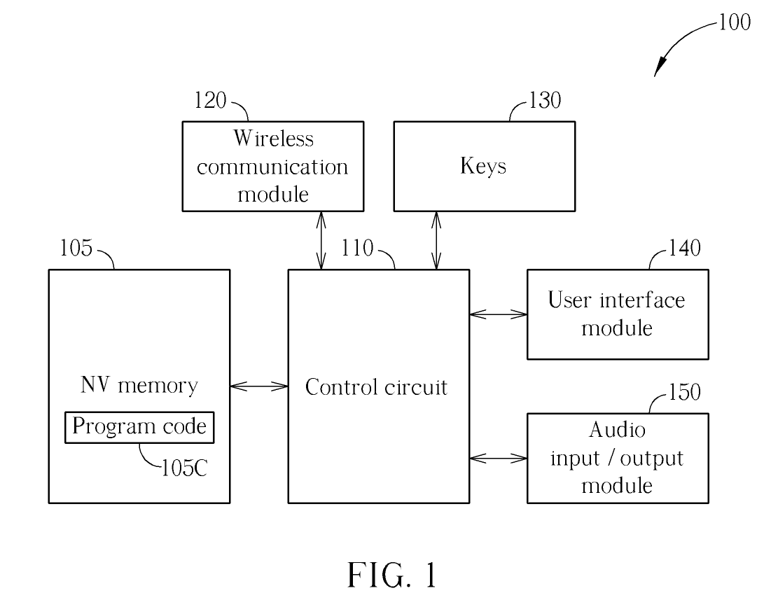

Please refer to FIG. 1, which illustrates a diagram of a portable apparatus 100 for being used in a telecommunication network according to a first embodiment of the present invention. The portable apparatus 100 of this embodiment is a portable electronic device equipped with multiple functionalities such as Personal Digital Assistant (PDA) and mobile phone functionalities. This is for illustrative purposes only, and is not meant to be a limitation of the present invention. According to a variation of this embodiment, the portable apparatus 100 can be a mobile phone. According to another variation of this embodiment, the portable apparatus 100 can be a PDA equipped with wireless communication capabilities.

As shown in FIG. 1, the portable apparatus 100 comprises a non-volatile (NV) memory 105, a control circuit 110, a wireless communication module 120, a plurality of keys 130 (e.g. hot keys), a user interface module 140, and an audio input/output module 150, where the NV memory 105 stores a program code 105C. For example, the control circuit 110 is a micro control unit (MCU), where the program code 105C is a firmware code and is received from outside the control circuit 110. In another example, the control circuit 110 is a micro processing unit (MPU), where the program code 105C is a software code and is received from outside the control circuit 110. This is for illustrative purposes only, and is not meant to be a limitation of the present invention. According to a variation of this embodiment, the control circuit 110 is a controller, where the program code 105C is a hardware code and is embedded within the control circuit 110. According to another variation of this embodiment, the control circuit 110 is an MPU, and the NV memory 105 is replaced with a storage module such as a hard disk drive (HDD), where the program code 105C is a software code stored in the HDD.

According to this embodiment, the control circuit 110 is arranged to control operations of the portable apparatus 100. More particularly, the control circuit 110 executing the program code 105C controls the operations of the portable apparatus 100. In addition, the wireless communication module 120 is arranged to perform wireless communication, and provides the portable apparatus 100 with a plurality of wireless communication capabilities. The wireless communication module 120 of this embodiment is capable of establishing a communication channel through an RF transceiver (not shown) of the wireless communication module 120. This is for illustrative purposes only, and is not meant to be a limitation of the present invention. According to variations of this embodiment, the communication module 120 provides the portable apparatus 100 with 2nd Generation (2G) wireless communication capability such as GSM, the so-called 2.5G wireless communication capability such as General Packet Radio Service (GPRS), 3rd Generation (3G) wireless communication capability such as Wideband Code Division Multiple Access (WCDMA), the so-called 3.5G wireless communication capability such as High-Speed Packet Access (HSPA), and/or 4G wireless communication capability such as WIMAX.

In this embodiment, the keys 130 (e.g. the hot keys mentioned above) can be arranged to trigger or control some functions of the portable apparatus 100. In addition, the user interface module 140 may comprise input devices such as a touch panel and a plurality of buttons. In practice, a liquid crystal display (LCD) of the touch panel is arranged to display information, and a user may read or view the information displayed by the LCD of the touch panel, and further control the portable apparatus 100 by using the touch panel and the buttons. This is for illustrative purposes only, and is not meant to be a limitation of the present invention. According to some variations of this embodiment, the buttons may comprise physical buttons and/or virtual buttons implemented with the touch panel. According to some variations of this embodiment, the keys 130 are not required since at least a portion of the buttons may replace the keys 130. Additionally, the audio input/output module 150 of this embodiment comprises audio processing and interfacing circuits, a microphone, and at least one speaker.

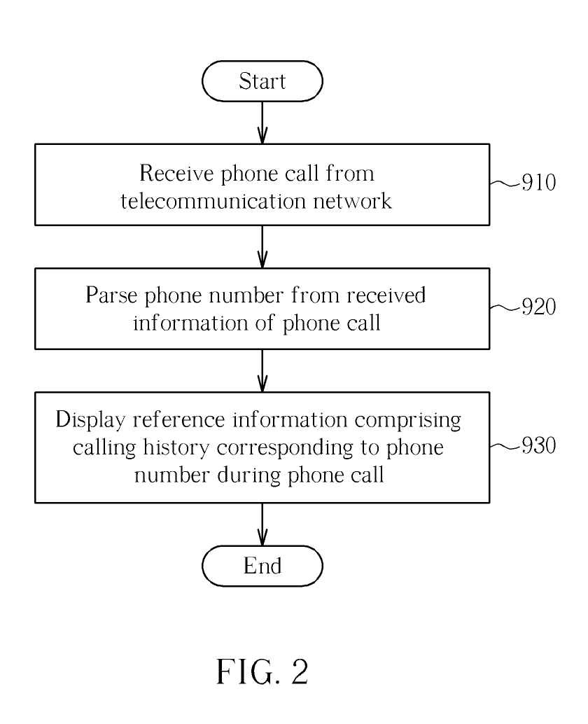

FIG. 2 is a flowchart of a method for controlling a portable apparatus used in a telecommunication network according to one embodiment of the present invention. The method shown in FIG. 2 can be applied to the portable apparatus 100, and more particularly, to the control circuit 110 executing the program code 105C. In addition, the method shown in FIG. 2 can be implemented by utilizing the portable apparatus 100, and more particularly, by utilizing the control circuit 110 executing the program code 105C. The method is described as follows.

In Step 910, the control circuit 110 executing the program code 105C receives a phone call from the telecommunication network by utilizing the wireless communication module 120.

In Step 920, the control circuit 110 executing the program code 105C parses a phone number from received information of the phone call.

In Step 930, under control of the control circuit 110 executing the program code 105C, the user interface module 140 (more specifically, the LCD of the touch panel mentioned above in this embodiment) displays reference information comprising a calling history corresponding to the phone number during the phone call. That is, under the control of the control circuit 110, the user interface module 140 can be arranged to display the reference information regarding a caller corresponding to the phone call.

In this embodiment, the reference information mentioned above represents the information that the user may consider valuable regarding the caller corresponding to the phone call, and can be utilized for reminding the user of what happened or something important. For example, the reference information comprises the calling history mentioned above, a memorandum (memo) previously made regarding the caller, at least one special day associated to the caller (e.g. the birthday of the caller), at least one document associated to the caller (e.g. an e-mail received from or sent to the caller), and/or representative(s) of at least one document associated to the caller (e.g. an e-mail record representing an e-mail received from or sent to the caller).

According to a special case of this embodiment, the memo may comprise video information and/or audio information previously recorded. For example, the video information may represent a video clip recorded in advance by using a camera connected to or installed within the portable apparatus 100, and under the control of the control circuit 110 executing the program code 105C, the user interface module 140 (more specifically, the LCD of the touch panel mentioned above in this embodiment) displays the video information such as the video clip. This is for illustrative purposes only, and is not meant to be a limitation of the present invention. According to different variations of this embodiment, the video clip can be recorded in advance by using a camera of another device, or by using some device(s) having video production functions, or by using some device(s) having image-capturing functions, image generation functions, and/or image-processing functions.

In another example, the audio information may represent an audio clip recorded in advance by using the audio input/output module 150, and under the control of the control circuit 110 executing the program code 105C, the audio input/output module 150 outputs the audio information such as the audio clip. This is for illustrative purposes only, and is not meant to be a limitation of the present invention. According to different variations of this embodiment, the audio clip can be recorded in advance by using a microphone of another device, or by using some device(s) having audio-synthesizing functions, or by using some device(s) having audio-receiving functions and/or audio-processing functions.

In practice, the video clip and the audio clip can be recorded at the same time and stored using the same file, so the memo may comprise both the video information and the audio information previously recorded.

According to this embodiment, under the control of the control circuit 110, the user interface module 140 is arranged to display a tabbed screen so that the user is allowed to select one of different views respectively corresponding to a plurality of tabs regarding the phone call. For example, the tabs represent different categories of the reference information mentioned above. As a result, the user can press a predetermined key out of the keys 130 to select an associated view corresponding to one of the tabs, in order to trigger the user interface module 140 (more specifically, the LCD of the touch panel mentioned above in this embodiment) to display associated information of a category selected by the user.

As a result of the operations disclosed above, when receiving the phone call using the portable apparatus 100, the user can see much more displayed information than that displayed on the display module of the mobile phone implemented according to the related art. Therefore, in contrast to the related art, the present invention method and the associated portable apparatus 100 can help the user to feel well prepared when receiving a phone call, bringing the user a comfortable communication experience.

It is another advantage of the present invention that, in a situation where communicating with a lot of persons using the portable apparatus 100 is required (e.g. the user is a very busy businessman or businesswoman), the present invention method and the associated portable apparatus 100 can prevent the user from tending to feel confused when receiving a phone call. As a result, the user may be more sophisticated when accidentally being forced to deal with annoying issues.

It is another advantage of the present invention that, in a situation where communicating with a lot of persons using the portable apparatus 100 is required, the present invention method and the associated portable apparatus 100 can help the user to determine whether an incoming phone call is an unwanted incoming phone call. Therefore, by considering the reference information, the user can easily filter out unwanted incoming phone calls without missing any important phone call.

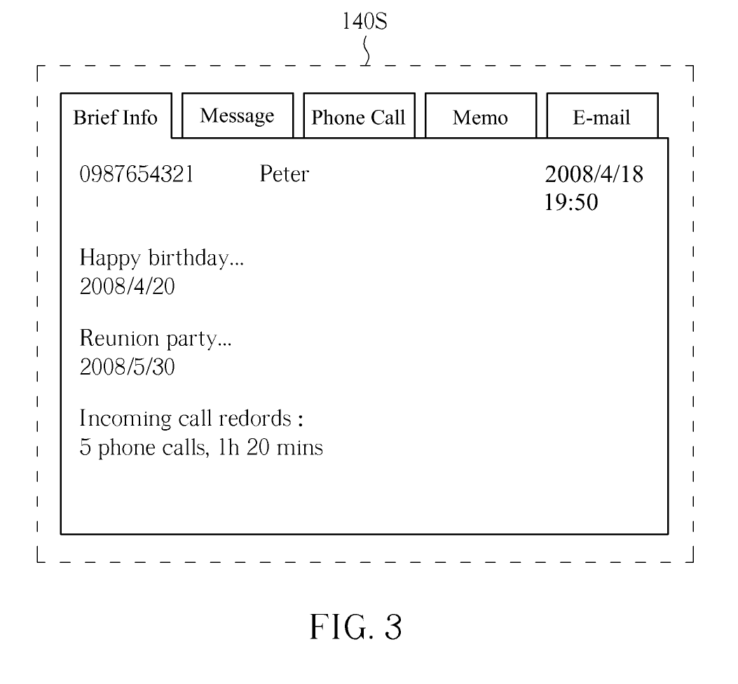

FIGS. 3-7 illustrate some implementation details of the method shown in FIG. 2 according to an embodiment of the present invention. As shown in FIGS. 3-7, at least a portion of the aforementioned reference information is displayed on the screen 1405 of the user interface module 140 (e.g. the LCD mentioned above) in accordance with the user's selection among the tabs.

Referring to FIG. 3, the tab labeled “Brief Info” represents brief information regarding the caller corresponding to the phone call mentioned in Step 910. For example, the brief information of this embodiment comprises a portion of the reference information, and further comprises partial or digest information of another portion of the reference information. As shown in FIG. 3, the brief information comprises the current date and time (e.g. the current date “Apr. 18, 2008” and the current time “19:50” displayed around the upper-right corner of the screen 140S), the phone number of the phone call (e.g. the phone number “0987654321” displayed around the upper-left corner of the screen 140S), and the name of the caller (e.g. the name “Peter” displayed next to the phone number). In addition, the brief information further comprises at least one special day associated to the caller, such as the birthday of the caller (e.g. the information “Happy birthday . . . Apr. 20, 2008” is displayed for indicating the birthday) and a date for a reunion party (e.g. the information “Reunion party . . . May 30, 2008” is displayed for indicating the date). Additionally, the brief information comprises the aforementioned partial or digest information, such as a summarized version of the calling history corresponding to the phone number (e.g. “Incoming call records: 5 phone calls, 1 h 20 mins” displayed around the lower-left corner of the screen 1405, for indicating that there are 5 incoming phone calls from the caller “Peter” and that the accumulated time of these incoming phone calls is approximately one hour and twenty minutes). When receiving the phone call, the brief information displayed on the screen 1405 can easily remind the user of what happened or something important.

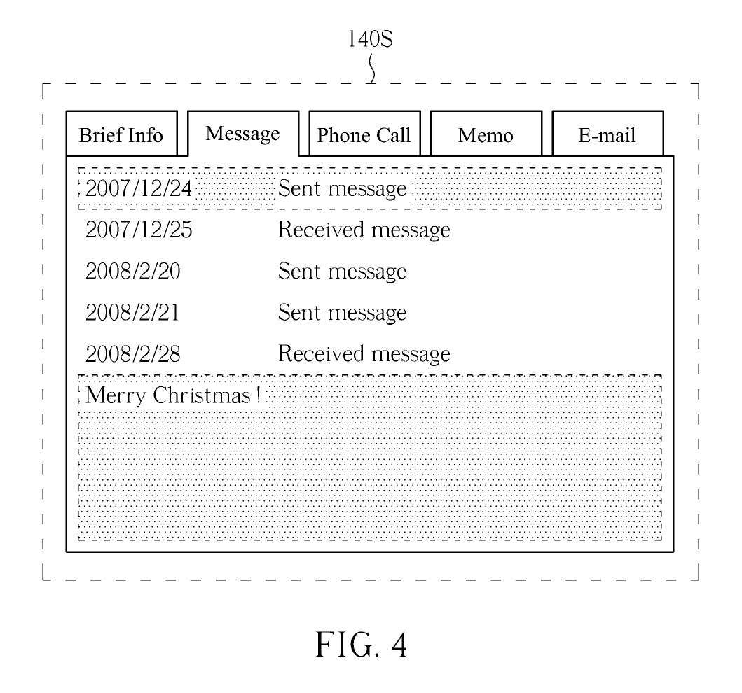

Referring to FIG. 4, the tab labeled “Message” represents short messages (e.g. messages of the Short Message Service (SMS)) regarding the caller corresponding to the phone call mentioned in Step 910. As shown in FIG. 4, the calling history of this embodiment comprises message record(s) of at least one short message (e.g. the message record “Dec. 24, 2007 Sent message” representing a message sent on Dec. 24, 2007, and the message record “Dec. 25, 2007 Received message” representing a message received on Dec. 25, 2007), and further comprises at least one short message received/sent before the phone call (e.g. the message “Merry Christmas!” corresponding to the highlighted message record “Dec. 24, 2007 Sent message”).

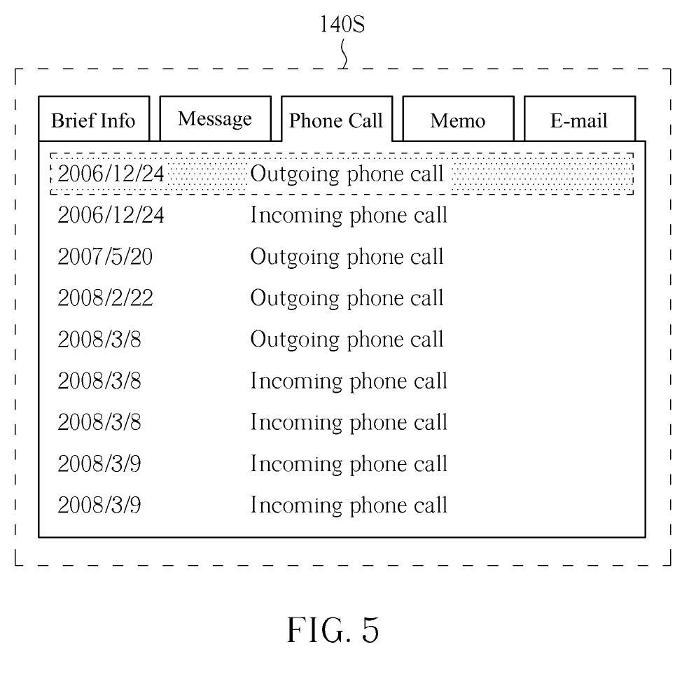

Referring to FIG. 5, the tab labeled “Phone Call” represents previous phone calls regarding the caller corresponding to the phone call mentioned in Step 910. As shown in FIG. 5, the calling history of this embodiment further comprises outgoing call record(s) of at least one phone call dialed before the phone call (e.g. the outgoing call record “Dec. 24, 2006 Outgoing phone call” representing an outgoing phone call dialed on Dec. 24, 2006), and further comprises incoming call record(s) of at least one phone call received before the phone call (e.g. the incoming call record “Dec. 24, 2006 Incoming phone call” representing an incoming phone call received on Dec. 24, 2006).

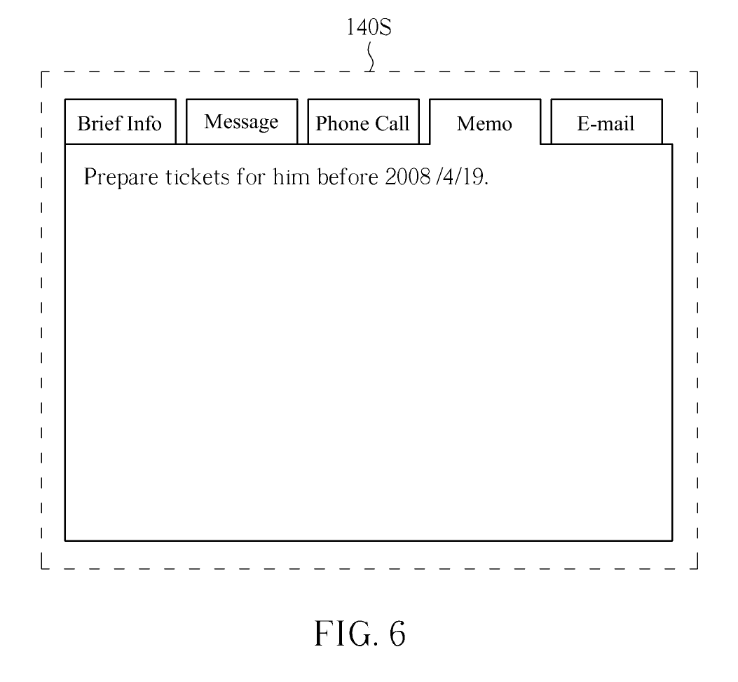

Referring to FIG. 6, the tab labeled “Memo” represents memos previously made regarding the caller corresponding to the phone call mentioned in Step 910. As shown in FIG. 6, the memo “Prepare tickets for him before Apr. 4, 2008.” is displayed to remind the user of something important, such as the commitment that the user already made to the caller in a previous conversion. In this embodiment, the memo shown in FIG. 6 reminds the user of preparing the tickets for the caller (e.g. the caller “Peter”) in time, and the user may realize that the purpose of this phone call probably relates to the tickets since the date indicated in this memo is exactly the next day.

Please note that the memo shown in FIG. 6 can be a text memo. This is for illustrative purposes only, and is not meant to be a limitation of the present invention. According to a variation of this embodiment, the memo can be an image memo having the same or similar meaning. For example, the image memo can be generated by scanning a document or a note, or by taking a picture of a document or a note. According to different variations of this embodiment, the memo may comprise the aforementioned video information previously recorded and/or the aforementioned audio information previously recorded, as disclosed in the aforementioned special case of the embodiment shown in FIG. 2 or in the variations thereof. Similar descriptions for these variations of this embodiment are not repeated in detail.

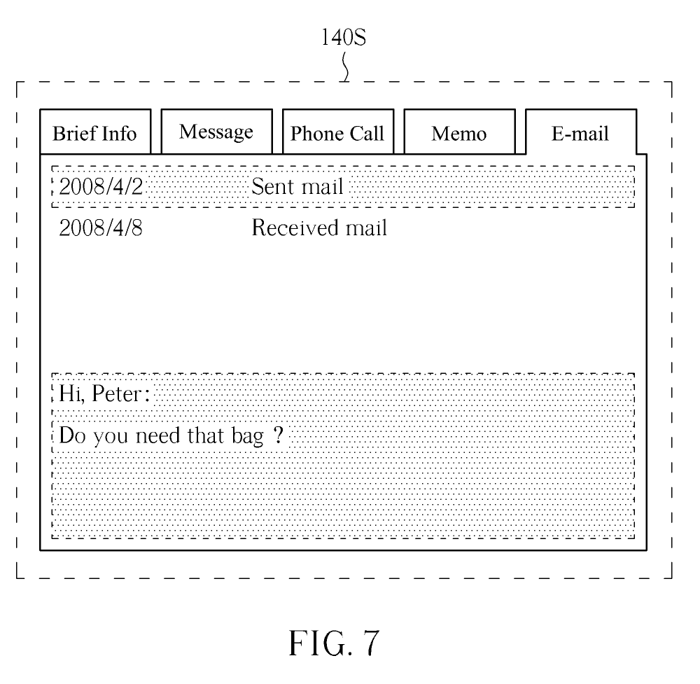

Referring to FIG. 7, the tab labeled “E-mail” represents e-mails regarding the caller corresponding to the phone call mentioned in Step 910. As shown in FIG. 7, the user interface module 140 is arranged to display representative(s) of at least one document associated to the caller (e.g. the e-mail record “Apr. 2, 2008 Sent mail” representing an e-mail sent on Apr. 2, 2008, and the e-mail record “Apr. 8, 2008 Received mail” representing an e-mail received on Apr. 8, 2008), and at least one document associated to the caller (e.g. the e-mail corresponding to the highlighted e-mail record “Apr. 2, 2008 Sent mail” with the e-mail contents comprising “Hi, Peter: Do you need that bag?”).

According to a variation of this embodiment, under the control of the control circuit 110, an audio mode of the portable apparatus 100 can be automatically activated according to user settings or default settings. In this variation, the audio input/output module 150 is arranged to output an audio calling history during the phone call in the audio mode. As a result of trigging the audio mode, the user can listen to audio version(s) of all or a portion of the reference information to be displayed according to the method shown in FIG. 2, such as the audio calling history mentioned above. Therefore, the user can substantially obtain all or the portion of the reference information without viewing the user interface module 140. Similar descriptions for this variation are not repeated in detail.

According to another variation of this embodiment, the control circuit 110 utilizes the user interface module 140 to provide a data maintenance interface that allows a user to categorize callers into groups, each of which has predetermined preference for displaying the calling history. For example, a first caller does not have any e-mail account, so the user may categorize the first caller into a group having predetermined preference for displaying the reference information without the tab labeled “E-mail”. In another example, the user may categorize a second caller into a group having predetermined preference for displaying the reference information with the information associated to a specific tab (e.g. the tab labeled “Memo”) having the highest display priority.

According to this variation, the data maintenance interface allows the user to make a memo regarding the caller corresponding to the phone call, where the memo is utilized for being displayed in the future when a future phone call corresponding to the same phone number is received. In addition, the data maintenance interface further allows the user to record an oral memo regarding the caller by utilizing the audio input/output module 150. The control circuit 110 performs an audio-to-text processing on the oral memo to generate a non-oral memo, where the non-oral memo is utilized for being displayed in the future when the future phone call or another future phone call corresponding to the same phone number is received. For example, the non-oral memo can be a text memo such as that shown in FIG. 6. In another example, the non-oral memo can be an image memo such as that mentioned above. Similar descriptions for this variation are not repeated in detail.

Please note that, although the tabbed screen is utilized in the embodiments/variations disclosed above, this is for illustrative purposes only, and is not meant to be a limitation of the present invention. According to some embodiments of the present invention, the reference information can be displayed without using tabbed screen. Similar descriptions for these embodiments are not repeated in detail.

Those skilled in the art will readily observe that numerous modifications and alterations of the device and method may be made while retaining the teachings of the invention.

What is claimed is:

1. A method for controlling a portable apparatus used in a telecommunication network, the method comprising:
receiving a phone call from the telecommunication network;
parsing a phone number from received information of the phone call; and
displaying reference information comprising a calling history corresponding to the phone number during the phone call.

2. The method of claim 1, further comprising:
displaying a tabbed screen so that a user is allowed to select one of different views respectively corresponding to a plurality of tabs regarding the phone call.

3. The method of claim 1, further comprising:
automatically activating an audio mode of the portable apparatus according to user settings or default settings of the portable apparatus; and
outputting an audio calling history during the phone call in the audio mode.

4. The method of claim 1, wherein the calling history comprises incoming call record(s) of at least one phone call received before the phone call, or comprises outgoing call record(s) of at least one phone call dialed before the phone call.

5. The method of claim 1, wherein the calling history comprises at least one short message received/sent before the phone call, or comprises message record(s) of at least one short message received/sent before the phone call.

6. The method of claim 1, wherein the reference information further comprises a memorandum (memo) previously made regarding a caller corresponding to the phone call.

7. The method of claim 6, wherein the memo comprises video information; and the method further comprises:
displaying the video information, wherein the video information represents a video clip recorded in advance.

8. The method of claim 6, wherein the memo comprises audio information; and the method further comprises:
outputting the audio information, wherein the audio information represents an audio clip recorded in advance.

9. The method of claim 1, wherein the reference information further comprises at least one special day associated to a caller corresponding to the phone call.

10. The method of claim 1, wherein the reference information further comprises at least one document associated to a caller corresponding to the phone call, or comprises representative(s) of at least one document associated to the caller.

11. The method of claim 1, further comprising:
providing a data maintenance interface that allows a user to categorize callers into groups, each of which has predetermined preference for displaying the reference information.

12. The method of claim 11, wherein the data maintenance interface allows the user to make a memorandum (memo) regarding a caller corresponding to the phone call; and the memo is utilized for being displayed in the future when a future phone call corresponding to the same phone number is received.

13. The method of claim 12, wherein the data maintenance interface allows the user to record an oral memo regarding the caller; and the method further comprises:
performing an audio-to-text processing on the oral memo to generate a non-oral memo, wherein the non-oral memo is utilized for being displayed in the future when the future phone call or another future phone call corresponding to the same phone number is received.

14. A portable apparatus for being used in a telecommunication network, the portable apparatus comprising:
a wireless communication module arranged to perform wireless communication;
a control circuit arranged to receive a phone call from the telecommunication network by utilizing the wireless communication module, wherein the control circuit parses a phone number from received information of the phone call; and
a user interface module arranged to display reference information comprising a calling history corresponding to the phone number during the phone call.

15. The portable apparatus of claim 14, wherein under control of the control circuit, the user interface module is arranged to display a tabbed screen so that a user is allowed to select one of different views respectively corresponding to a plurality of tabs regarding the phone call.

16. The portable apparatus of claim 14, wherein under control of the control circuit, an audio mode of the portable apparatus is automatically activated according to user settings or default settings of the portable apparatus; and the portable apparatus further comprises:
an audio input/output module arranged to output an audio calling history during the phone call in the audio mode.

17. The portable apparatus of claim 14, wherein the calling history comprises incoming call record(s) of at least one phone call received before the phone call, or comprises outgoing call record(s) of at least one phone call dialed before the phone call.

18. The portable apparatus of claim 14, wherein the calling history comprises at least one short message received/sent before the phone call, or comprises message record(s) of at least one short message received/sent before the phone call.

19. The portable apparatus of claim 14, wherein the reference information further comprises a memorandum (memo) previously made regarding a caller corresponding to the phone call.

20. The portable apparatus of claim 19, wherein the memo comprises video information; and under control of the control circuit, the user interface module displays the video information, wherein the video information represents a video clip recorded in advance.

21. The portable apparatus of claim 19, wherein the memo comprises audio information; and the portable apparatus further comprises:
an audio input/output module arranged to output the audio information under control of the control circuit, wherein the audio information represents an audio clip recorded in advance.

22. The portable apparatus of claim 14, wherein the reference information further comprises at least one special day associated to a caller corresponding to the phone call.

23. The portable apparatus of claim 14, wherein the reference information further comprises at least one document associated to a caller corresponding to the phone call, or comprises representative(s) of at least one document associated to the caller.

24. The portable apparatus of claim 14, wherein the control circuit utilizes the user interface module to provide a data maintenance interface that allows a user to categorize callers into groups, each of which has predetermined preference for displaying the reference information.

25. The portable apparatus of claim 24, wherein the data maintenance interface allows the user to make a memorandum (memo) regarding a caller corresponding to the phone call; and the memo is utilized for being displayed in the future when a future phone call corresponding to the same phone number is received.

26. The portable apparatus of claim 25, wherein the data maintenance interface allows the user to record an oral memo regarding the caller; the control circuit performs an audio-to-text processing on the oral memo to generate a non-oral memo; and the non-oral memo is utilized for being displayed in the future when the future phone call or another future phone call corresponding to the same phone number is received.
